(19) United States
(12) Patent Application Publication
(10) Pub. No.: US 2022/0156035 A1
(43) Pub. Date: May 19, 2022

(54) METHOD OF GENERATING ACTIONS FOLLOWING THE RHYTHM OF MUSIC

(71) Applicant: AMERICAN FUTURE TECHNOLOGY, City of Industry, CA (US)

(72) Inventor: You-Chi LIU, City of Industry, CA (US)

(21) Appl. No.: 17/116,519

(22) Filed: Dec. 9, 2020

Related U.S. Application Data
(63) Continuation-in-part of application No. 17/098,898, filed on Nov. 16, 2020.

(51) Int. Cl. G06F 3/16; G10L 25/18; G10L 25/51; G10L 25/90

(52) U.S. Cl. CPC G06F 3/165; G10L 25/18; G10H 2210/071; G10L 25/90; G10L 25/51

(57) ABSTRACT

A method of generating actions following the rhythm of music includes the steps of (a) using an electronic device to classify the sound signals from plural musical instruments into a complex pitch range, (b) the electronic device performing Fourier series conversion on the sound signals of the complex pitch range to obtain plural rhythm diagrams, (c) the electronic device performing a rhythm change point capture action on each rhythm diagram, and then executing no action if the intensity in the rhythm diagram continues to increase with time, or regarding the point as a rhythm change point if the intensity changes from an increase to a decrease, and then transmitting an action signal to an action device, and (c) the action device executing the corresponding action according to the action signal.

This application is a Continuation-In-Part of application Ser. No. 17/098,898, filed on Nov. 16, 2020, for which priority is claimed under 35 U.S.C. § 120, the entire contents of which are hereby incorporated by reference.

### BACKGROUND OF THE INVENTION

### 1. Field of the Invention

The present invention relates to a method of generating actions following the rhythm of music, which uses an electronic device to classify the sound signals from plural musical instruments into a complex pitch range and then to perform Fourier series conversion on the sound signals of the complex pitch range to obtain plural rhythm diagrams of the complex pitch range, and then, the electronic device drives an action device to perform a corresponding action when the intensity in each rhythm diagram changes from an increase to a decrease. In this way, when the audience listens to the music, they can see or feel the action following the rhythm of the music, which can enhance the overall performance and appreciation of the music.

### 2. Description of the Related Art

With the rapid development of science and technology, it is difficult to meet people's sensory needs for pure auditory enjoyment. Therefore, more and more musical devices will give the audience more experience visually, so as to provide the audience with more different atmospheres in the process of listening to music. However, most of the music and lighting interactive devices are controlled by lighting manufacturers through system presents. For example, adjust the color and brightness of the light in the program in advance with the performance of the music, or through the style and rhythm of the music, and then it can be broadcast at the same time during the performance.

However, this pre-set method cannot make the combination of music and lighting achieve the optimal effect, and it may also make the sensory experience poor, so as to reduce the music atmosphere on site. Moreover, if the amount of music is too much, the lighting manufacturers spend a lot of time and effort, so most of them will not provide a lighting interaction for every piece of music. Moreover, the current lighting manufacturers adjust the color and brightness of the light according to the level of sound and the switching position of the frequency. However, through the aforementioned two methods, the light interaction will be too disordered, which will cause discomfort. However, people feel that the combination of music changes because of the rhythm in the music. The rhythm is the embodiment of the time, sequence, strength and weakness of the music. Through the rhythm, the music will proceed in an orderly manner.

Therefore, how to automatically extract the rhythm from the music and produce an action effect in accordance with the rhythm is the direction that the related industries in this art urgently want to study and improve.

### SUMMARY OF THE INVENTION

The present invention has been accomplished under the circumstances in view. It is the main object of the present invention to provide a method of generating actions following the rhythm of music, which comprises the step of using an electronic device to classify the sound signals from plural musical instruments into a complex pitch range, the step of enabling the electronic device to perform Fourier series conversion on the sound signals of the complex pitch range to obtain plural rhythm diagrams of the complex pitch range where each rhythm diagram represents the intensity change of at least one frequency in the sound signal over time, the step of enabling the electronic device to perform a rhythm change point capture action on each rhythm diagram, and then the electronic device executes no action if the intensity in said rhythm diagram continues to increase with time, or the point is regarded as a rhythm change point if the intensity changes from an increase to a decrease, and then the electronic device transmits an action signal to an action device, and the step of enabling the action device to execute the corresponding action according to the action signal, so that when the audience listens to the music, they can see or feel the action following the rhythm of the music, which can enhance the overall performance and appreciation of the music.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a rhythm diagram of the present invention.

FIG. 2 is a flow chart of the present invention.

FIG. 3 is a pitch range chart of the present invention.

### DETAILED DESCRIPTION OF THE PREFERRED EMBODIMENT

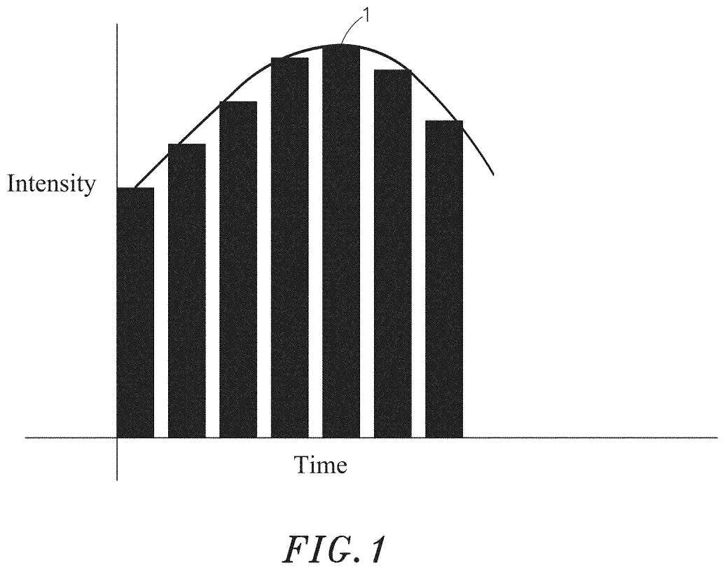

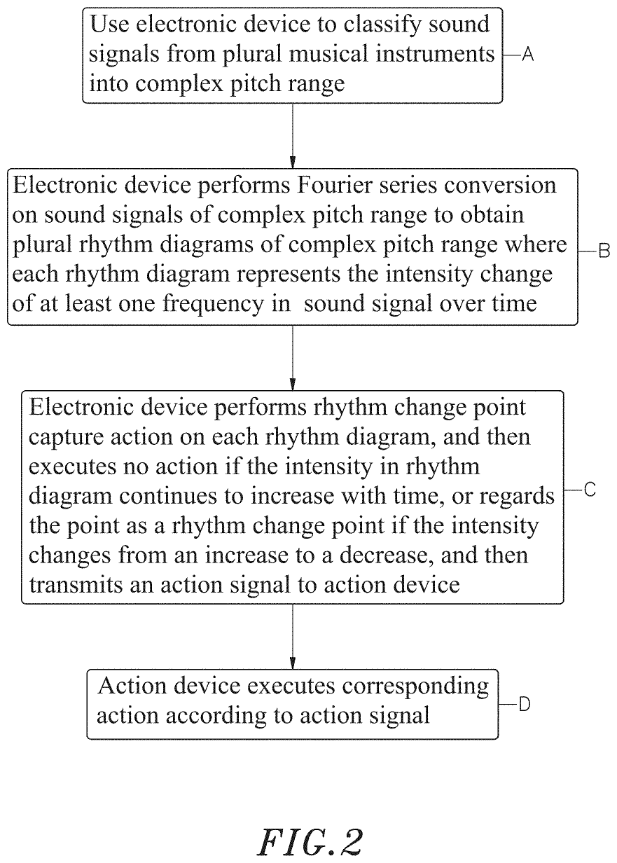

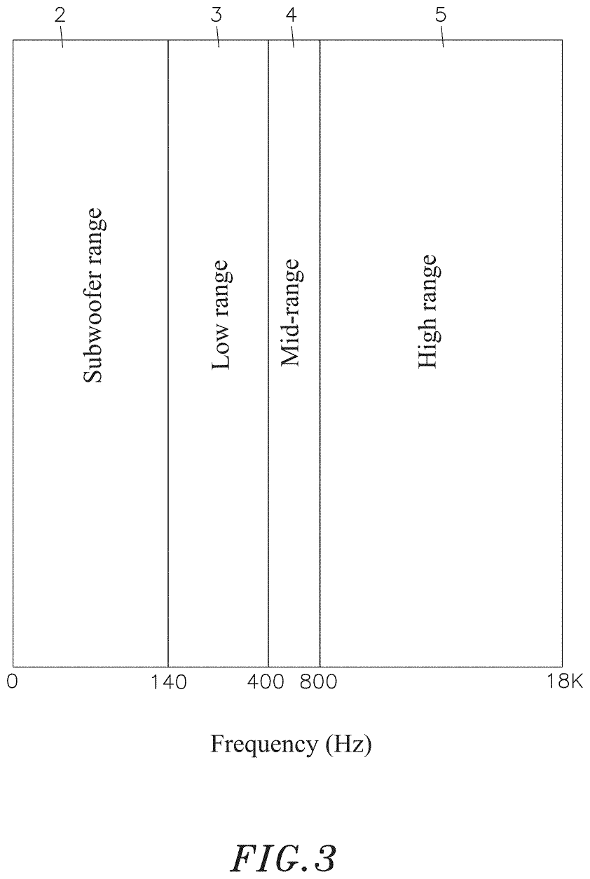

Referring to FIGS. 1-3, a rhythm diagram of the present invention, a flow chart of the present invention and a pitch range diagram of the present invention are shown. The method of generating actions following the rhythm of music in accordance with the present invention comprises the steps of:

(a) Use an electronic device to classify the sound signals from plural musical instruments (such as guitars, drums, bass, piano, cymbals or other musical instruments) into a complex pitch range.

(b) The electronic device then performs Fourier series conversion on the sound signals of the complex pitch range to obtain plural rhythm diagrams of the complex pitch range where each rhythm diagram represents the intensity change of at least one frequency in the sound signal over time.

(c) The electronic device performs a rhythm change point 1 capture action on each rhythm diagram, then executes no action if the intensity in the rhythm diagram continues to increase with time, or regards the point as the rhythm change point 1 if the intensity changes from an increase to a decrease and at this time, the electronic device transmits an action signal to an action device.

(d) After received the action signal, the action device executes the corresponding action according to the action signal to complete the use of the present invention.

The above-mentioned electronic device can be a desktop computer, notebook computer, tablet computer, smart phone, personal digital assistant or other electronic devices with computing functions.

Furthermore, the complex pitch range in the above step (a) includes the subwoofer range 2, the low range 3, the mid-range 4, and the high range 5. The frequency range of the subwoofer range 2 is between 0˜140 Hz, the frequency range of the low range 3 is between 140˜400 Hz, the frequency range of the mid-range 4 is between 400˜800 Hz, the frequency range of the high range 5 is between 800˜18000 Hz.

The electronic device in the above step (c) preferably can transmit the action signal to the action device through a transmission line, but in practical applications, it can also use wireless transmission methods (such as: Wi-Fi, Bluetooth or infrared, etc.) to transmit the action signal to the action device.

Furthermore, the action device in the above step (c) can be a light-emitting device (such as: LED), a water spray device, a fire spray device, a dry ice spray device, a pyrotechnic device or other action devices that can perform actions in conjunction with music broadcasting, and thus, you can use the light-emitting device to match the rhythm of the light change, simulate the water dance change, simulate the torch change or any scene lighting special effect change, or you can use a water spray device, a fire spray device, a dry ice spray device, a pyrotechnic device or other action devices to spit fire, spray water, spray dry ice, set off fireworks or other actions. However, there are many types of related action devices, which can receive action signals to perform actions in accordance with the rhythm of the music. Therefore, all structures that can achieve the aforementioned effects should be covered by the present invention. Such simple modifications and equivalent structural changes should be included in the scope of the patent of the present invention for the same reason.

When the present invention is actually used, the electronic device classifies the sound signals from plural musical instruments into a complex pitch range (e.g.: subwoofer range 2 between 0˜140 Hz, low range 3 between 140˜400 Hz, mid-range 4 between 400˜800 Hz, and high range 5 between 800˜18000 Hz), then, the electronic device performs Fourier series conversion on the sound signals of the complex pitch range to obtain plural rhythm diagrams of the complex pitch range, and then, the electronic device performs a rhythm change point 1 capture action on each rhythm diagram. If the intensity in the rhythm diagram continues to increase with time, the electronic device executes no action. If the intensity changes from an increase to a decrease and at this time, the point is regarded as the rhythm change point 1 (at the apex of the wave front in the diagram). At this time, the electronic device transmits an action signal to an action device. After received the action signal, the action device executes the corresponding action according to the action signal. That is to say, the action device can perform actions according to the rhythm played by plural musical instruments, so that when the audience listens to the music, they can see or feel the action following the rhythm of the music, which can enhance the overall performance and appreciation of the music.

The above is only the preferred embodiment of the present invention, and it does not limit the patent scope of the present invention. Therefore, all simple modifications and equivalent structural changes made by using the description and schematic content of the present invention should be included within the scope of the patent of the present invention.

In summary, the method of generating actions following the rhythm of music of the present invention can indeed achieve its efficacy and purpose in practical applications, so the present invention is a research and development with excellent practicability, and it meets the requirements of an invention patent application.

What the invention claimed is:

1. A method of generating actions following the rhythm of music, comprising the steps of:
(a) using an electronic device to classify the sound signals from plural musical instruments into a complex pitch range;
(b) said electronic device then performing Fourier series conversion on the sound signals of said complex pitch range to obtain plural rhythm diagrams of the complex pitch range where each said rhythm diagram represents the intensity change of at least one frequency in the sound signal over time;
(c) said electronic device then performing a rhythm change point capture action on each said rhythm diagram, then executes no action if the intensity in the respective said rhythm diagram continues to increase with time, or regards the point as a rhythm change point if the intensity changes from an increase to a decrease and at this time, said electronic device transmitting an action signal to an action device; and
(d) said action device executing the corresponding action according to said action signal after received said action signal.

2. The method of generating actions following the rhythm of music as claimed in claim 1, wherein said electronic device is selectively a desktop computer, a notebook computer, a tablet computer, a smart phone, or a personal digital assistant.

3. The method of generating actions following the rhythm of music as claimed in claim 1, wherein said complex pitch range in the step (a) includes a subwoofer range, a low range, a mid-range, and a high range.

4. The method of generating actions following the rhythm of music as claimed in claim 3, wherein the frequency range of said subwoofer range is between 0˜140 Hz, the frequency range of said low range is between 140˜400 Hz, the frequency range of said mid-range is between 400˜800 Hz, and the frequency range of said high range is between 800˜18000 Hz.

5. The method of generating actions following the rhythm of music as claimed in claim 1, wherein said action device is selectively a light-emitting device, a water spray device, a fire spray device, a dry ice spray device, or a pyrotechnic device.
